(19) United States
(12) Patent Application Publication
(10) Pub. No.: US 2026/0342188 A1
(43) Pub. Date: Oct. 29, 2026

(54) INDUCTION ROTOR INCLUDING CAGE WITH SEGMENTED ROTOR BARS

(71) Applicant: GM GLOBAL TECHNOLOGY OPERATIONS LLC, Detroit, MI (US)

(72) Inventors: Alireza FATEMI, Canton, MI (US); Thomas W. Nehl, Shelby Township, MI (US); Peng Peng, Rochester Hills, MI (US); Derek Frei Lahr, Ann Arbor, MI (US)

(21) Appl. No.: 19/187,290

(22) Filed: Apr. 23, 2025

(51) Int. Cl. H02K 17/16; H02K 3/12

(52) U.S. Cl. CPC H02K 17/168; H02K 3/12

(57) ABSTRACT

An induction motor includes a stator including windings. A rotor is arranged inside of the stator and includes a stack of rotor laminations. A plurality of slots are arranged adjacent to a radially outer edge of the stack of rotor laminations. A cage includes a plurality of segmented rotor bars arranged in the plurality of slots and segmented in at least one of a radial direction and a circumferential direction. The plurality of segmented rotor bars are segmented in one of a circumferential direction and a radial direction. The plurality of segmented rotor bars in each of the slots have a decreasing cross sectional area in a direction towards an air gap. The plurality of segmented rotor bars include an insulating coating. Metal end disks or end caps are arranged at opposite sides of the stack of laminations.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to electric motors, and more particularly to an induction motor including a rotor with a cage including segmented rotor bars.

Electric, hybrid, and fuel cell vehicles typically include an electric motor, a battery system including battery packs, modules, and/or cells, a power inverter, and a battery management system. In some examples, the electric motor includes an induction motor. A stator of the induction motor includes windings that produce a rotating magnetic field. A rotor rotates within the stator and includes rotor laminations with slots formed on radially outer surfaces thereof. Rotor bars extend longitudinally in an axial direction in the slots. The rotating magnetic field produced by the stator induces an electric field in the rotor bars that generates time-varying currents in the rotor bars that rotate the rotor and produce drive torque.

### SUMMARY

A rotor for an induction motor includes a stack of rotor laminations and a plurality of slots arranged adjacent to a radially outer edge of the stack of rotor laminations. A cage includes a plurality of segmented rotor bars arranged in the plurality of slots and segmented in at least one of a radial direction and a circumferential direction.

In other features, the plurality of segmented rotor bars are segmented in a circumferential direction. The plurality of segmented rotor bars are segmented in a radial direction. The plurality of segmented rotor bars in each of the slots include different cross sectional areas. The plurality of segmented rotor bars in each of the slots have a decreasing cross sectional area in a direction towards an air gap. The plurality of segmented rotor bars include one of an insulating coating and an insulating layer.

In other features, spacers are arranged between the plurality of segmented rotor bars. The plurality of segmented rotor bars extend in an axial direction beyond the stack of laminations.

In other features, a first metal end disk and a second metal end disk are arranged at opposite sides of the stack of laminations, respectively. Opposite ends the plurality of segmented rotor bars extend into corresponding cavities in the first and second metal end disks.

In other features, the opposite ends of the plurality of segmented rotor bars are welded to the first and second metal end disks. The first metal end disk and the second metal end disk have higher mechanical strength than the plurality of segmented rotor bars.

In other features, the first metal end disk and the second metal end disk have lower electrical conductivity than the plurality of segmented rotor bars. End caps are cast around the opposite ends the plurality of segmented rotor bars.

An induction motor includes a stator including windings. A rotor is arranged inside of the stator and includes a stack of rotor laminations. A plurality of slots are arranged adjacent to a radially outer edge of the stack of rotor laminations. A cage includes a plurality of segmented rotor bars arranged in the plurality of slots and segmented in at least one of a radial direction and a circumferential direction.

In other features, the plurality of segmented rotor bars are segmented in one of a circumferential direction and a radial direction. The plurality of segmented rotor bars include different cross sectional areas. The plurality of segmented rotor bars in each of the slots have a decreasing cross sectional area in a direction towards an air gap. The plurality of segmented rotor bars include an insulating coating.

In other features, a first metal end disk and a second metal end disk arranged at opposite sides of the stack of laminations. The plurality of segmented rotor bars extend in an axial direction beyond the stack of laminations. Opposite ends the plurality of segmented rotor bars extend into cavities in the first and second metal end disks. The opposite ends the plurality of segmented rotor bars are welded to the first and second metal end disks.

In other features, the induction motor includes first and second end caps. The plurality of segmented rotor bars extend in an axial direction beyond the stack of laminations. The first and second end caps are cast around the opposite ends the plurality of segmented rotor bars.

A vehicle includes an induction motor comprising a stator including windings and a rotor including a stack of rotor laminations, a plurality of slots arranged adjacent to a radially outer edge of the stack of rotor laminations, and a cage including a plurality of segmented rotor bars arranged in the plurality of slots and segmented in at least one of a radial direction and a circumferential direction. The plurality of segmented rotor bars include different cross sectional areas. The plurality of segmented rotor bars in each of the slots have a decreasing cross sectional area in a direction towards an air gap. The vehicle includes a battery system and a power inverter configured to supply power from the battery system to the windings of the induction motor. At least one driven wheel is propelled by the induction motor.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a vehicle including an induction motor with a rotor including laminations and segmented rotor bars according to the present disclosure;

FIGS. 2A and 2B are side cross sections of examples of the induction motor including a rotor with segmented rotor bars according to the present disclosure;

FIGS. 2C and 2D are side views of examples of rotors with non-skewed segmented rotor bars and skewed segmented rotor bars, respectively, according to the present disclosure;

FIG. 3 is a front view of an example of a portion of laminations of a rotor according to the present disclosure;

FIG. 4 is a front view of an example of a portion of a rotor including laminations and segmented rotor bars according to the present disclosure;

FIGS. 5A and 5B are front views of examples of rotor bars segmented in a radial direction according to the present disclosure;

FIG. 5C is a front view of a segmented rotor bar encapsulated in epoxy or varnish in a slot of the laminations according to the present disclosure;

FIG. 5D is a front view of a segment including tightly bundled conductors;

FIG. 6 is a front views of another example of a rotor bar segmented in a circumferential direction according to the present disclosure.

In the drawings, reference numbers may be reused to identify similar and/or identical elements.

### DETAILED DESCRIPTION

While a rotor and induction motor including the rotor are described herein in the context of a vehicle, the induction motor can be used in stationary or other applications.

The induction motor according to the present disclosure includes a rotor including laminations defining slots extending to or adjacent to radially outer edges of the laminations. The rotor includes a squirrel cage or cage defined by a plurality of rotor bars located in the slots located around the radially outer edge of the laminations. The plurality of rotor bars are segmented in circumferential and/or radial directions according to the present disclosure to reduce alternating current (AC) induced losses at high speeds (as compared to monolithic rotor bars). In some examples, opposing ends of the plurality of segmented rotor bars extend beyond the laminations and are cast into end caps or welded to one or more planar end disks to short ends of the segmented rotor bars. The end caps or end disks provide a return current path for the plurality of segmented rotor bars.

In some examples, the segments of the segmented rotor bars have cross sections (in a plane transverse to the axial direction) with different shapes resulting in conductors with different cross-sectional areas. In some examples, the segments of the segmented rotor bars have a segmentation pattern defined by segments with decreasing conductor cross-sectional areas in a direction towards the airgap between the stator and rotor.

The end disks are welded/connected to opposing axial ends of the segmented rotor bars to short circuit the individual segments and bars. In some examples, the end disks are made of a mechanically stronger conductor alloy than the segmented rotor bars to increase mechanical strength. In some examples, the segments of the segmented rotor bars use a conductor with higher electrical conductivity than the end disks.

In some examples, the segments of the segmented rotor bars are inserted into slots in the rotor laminations. Then, the end disks are installed over opposing ends of the segmented rotor bars and welded. In some examples, multiple end disks are used at each end. In some examples, the end disks are installed one at a time and the welds are made along edges of the segmented rotor bars between each of the end disks. Alternately, the end disks and segmented rotor bars are welded circumferentially between the end disks after the end disks are installed. In other examples, the end caps are cast over opposite ends of the segmented rotor bars.

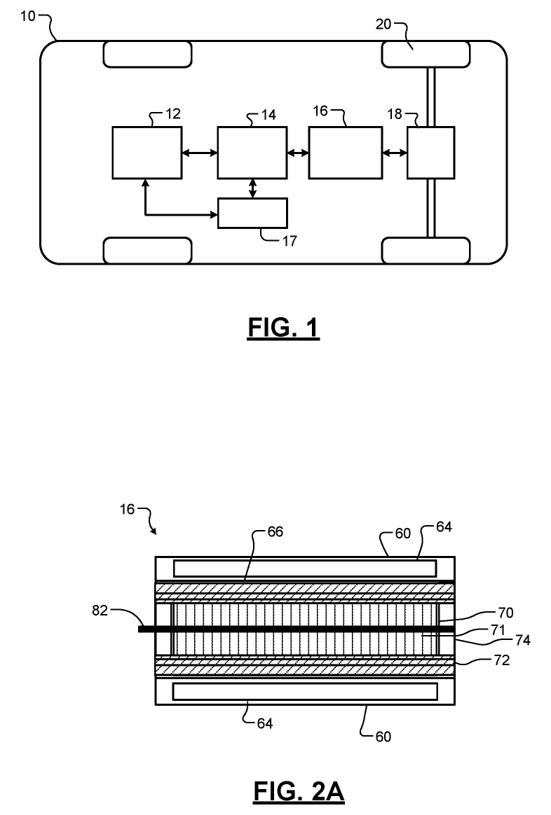

Referring now to FIG. 1, a vehicle 10 includes one or more induction motors 16 driving one or more wheels of the vehicle 10. The induction motor 16 includes a rotor including laminations and segmented rotor bars as will be described further below. A battery system 12 outputs power via a power inverter 14 to the one or more induction motors 16 to produce drive torque. A battery management system 17 controls the power inverter 14 based on driver input and/or sensed battery, inverter, and/or motor parameters. The induction motor 16 may be directly coupled to wheels 20 of the vehicle 10 or a driveline 18 may be used.

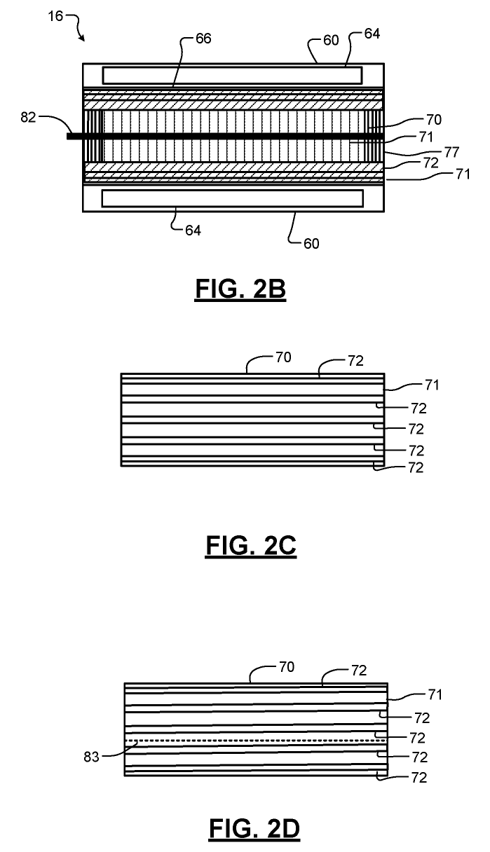

Referring now to FIGS. 2A-2D, the induction motor 16 includes a stator 60 including windings 64. In FIG. 2A, a rotor 70 is arranged inside a cylindrical cavity defined by the stator 60. An air gap 66 is defined between a radially outer surface of the rotor 70 and a radially inner surface of the stator 60. The rotor 70 and a shaft 82 rotate relative to the stator 60.

The rotor 70 includes a stack of rotor laminations 71 defining radial slots located adjacent to a radially outer edge thereof. The rotor 70 includes a plurality of segmented rotor bars 72 and end caps or disks located at opposite axial ends of the rotor 70. In FIG. 2A, end caps 74 are cast around axial ends of the plurality of segmented rotor bars 72. In FIG. 2B, the plurality of segmented rotor bars 72 pass through aligned cavities in one or more planar end disks 77. In some examples, the plurality of segmented rotor bars 72 are welded to the one or more planar end disks 77 along circumferential edges between the one or more planar end disks 77. In other examples, each of the one or more planar end disks 77 is assembled and then welded around outer edges of the plurality of segmented rotor bars 72 on an outer exposed surface (and then the process is repeated for next end disk and so on).

In FIG. 2C, the rotor 70 includes the segmented rotor bars 72 that are not skewed. In other words, the segmented rotor bars 72 extend along a line parallel to an axial direction. In FIG. 2D, the rotor 70 includes the segmented rotor bars 72 that are skewed at a skew angle. In other words, the segmented rotor bars 72 extend at angle relative to a line parallel to an axial direction.

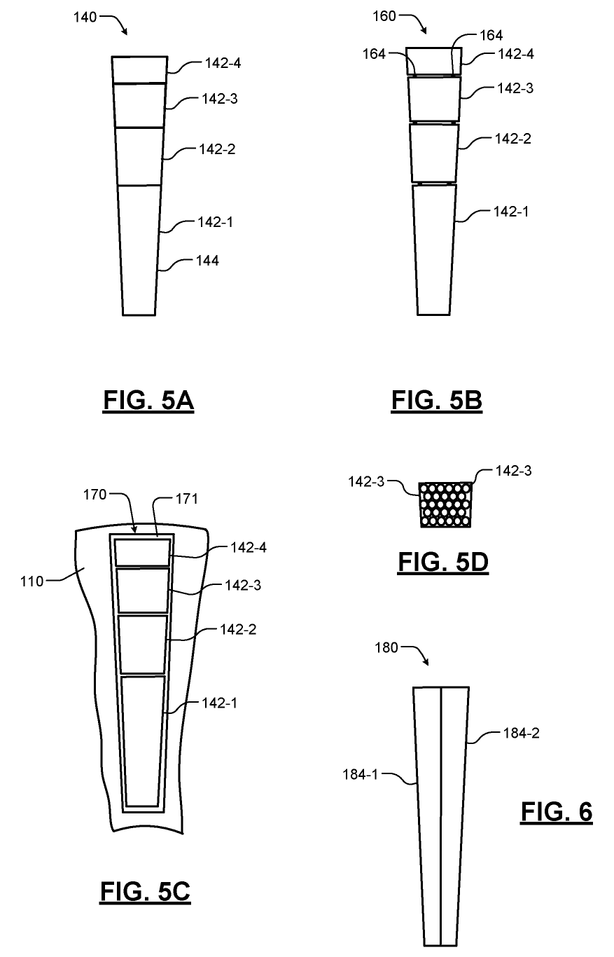

Referring now to FIG. 3, a lamination 110 of a portion of the rotor 70 includes slots 114 configured to receive the segmented rotor bars. The laminations 110 can span 360º/L, where L is an integer (e.g., L=4 in FIG. 3). In some examples, the laminations 110 are made of electrical steel such as silicon steel or cobalt steel. In some examples, the segmented rotor bars are made of pure copper, pure aluminum, or an alloy of copper and aluminum. In some examples, the slots 114 include an opening 115 at a radially outer end that is configured to engage the segmented rotor bars. For example, the circumferential opening 115 in FIG. 3 is narrower than a width of the segmented rotor bars in a circumferential direction to mechanically hold the segmented rotor bars in place. In other examples, radially outer ends are surrounded by the laminations as shown in FIG. 5C.

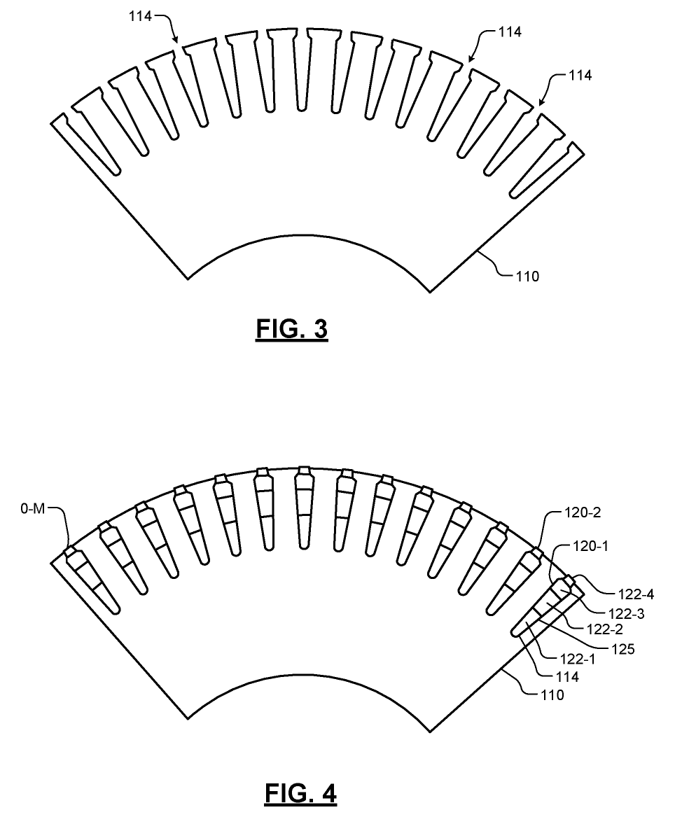

Referring now to FIG. 4, segmented rotor bars 120 are arranged in the slots 114 of the laminations 110 of the rotor 70. In some examples, the segmented rotor bars 120 are segmented in a radial direction. For example, the segmented rotor bars 120 include rotor bar segments 120-1, 120-2, …, and 120-R, where R is an integer greater than one. In FIG. 4, R=4, although additional or fewer segments can be used.

In some examples, each of the rotor bar segments 120-1, 120-2, …, and 120-R has a decreasing cross sectional area (in a plane transverse to an axial direction) in a direction towards the air gap. In some examples, the segmented rotor bars 120 include an insulating coating or layer 125. The insulating coating or layer 125 is masked or mechanically removed to allow connections to the end caps or end disks. In some examples, the segmented rotor bars 120 are encapsulated with varnish, epoxy, or other coating to mechanically retain them in the slots 114. In some examples, the segmented rotor bars 120 rely on high contact resistance between segments to provide insulation. Each of the rotor bar segments 120-1, 120-2, …, and 120-R is in contact with and tightly bundled with adjacent ones of the rotor bar segments 120-1, 120-2, …, and 120-R.

Referring now to FIGS. 5A and 5B, examples of segmented rotor bars that are segmented in a radial direction are shown. In FIG. 5A, a segmented rotor bar 140 includes rotor bar segments 142-1, 142-2, 142-3, and 142-4. In some examples, the rotor bar segments 142-1, 142-2, 142-3, and 142-4 are coated with an insulating coating or layer 144. In FIG. 5B, spacers 164 are arranged between the rotor bar segments 142-1, 142-2, 142-3, and 142-4 to create an air gap.

In FIG. 5C, a rotor bar 170 is encapsulated in epoxy or varnish 171 in a slot of the laminations 110. In some examples, the segmented rotor bars are encapsulated in the epoxy or varnish 171 with the rotor bar segments separated by a gap (shown), insulated, and/or in direct contact.

The segments can be solid conductors as shown in FIGS. 5A-5C. In FIG. 5D, the segments (such as segment 142-3) can include a plurality of tightly bunded wire conductors 149 have a predetermined outer shape corresponding to one of the segments. In some examples, the outer shape is trapezoidal, teardrop, or other suitable shape. The wire conductors 149 are wound and compacted to form the shape of one of the segments. In some examples, all of the segments are inserted together into the rotor slot (as opposed to inserting individual segments). In some examples, each of the wire conductors includes a thin insulation coating.

Referring now to FIG. 6, a segmented rotor bar 180 includes rotor bar segments 184-1 and 184-2 that are segmented in circumferential direction in a plane transverse to the axial direction. In some examples, the rotor bar segments 184-1 and 184-2 have a width that increases in a radial direction towards the air gap.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A rotor for an induction motor comprising:
a stack of rotor laminations;
a plurality of slots arranged adjacent to a radially outer edge of the stack of rotor laminations; and
a cage including a plurality of segmented rotor bars arranged in the plurality of slots and segmented in at least one of a radial direction and a circumferential direction.

2. The rotor of claim 1, wherein the plurality of segmented rotor bars are segmented in a circumferential direction.

3. The rotor of claim 1, wherein the plurality of segmented rotor bars are segmented in a radial direction.

4. The rotor of claim 1, wherein the plurality of segmented rotor bars in each of the slots include different cross sectional areas.

5. The rotor of claim 1, wherein the plurality of segmented rotor bars in each of the slots have a decreasing cross sectional area in a direction towards an air gap.

6. The rotor of claim 1, wherein the plurality of segmented rotor bars include one of an insulating coating and an insulating layer.

7. The rotor of claim 1, further comprising spacers arranged between the plurality of segmented rotor bars.

8. The rotor of claim 1, wherein the plurality of segmented rotor bars extend in an axial direction beyond the stack of laminations.

9. The rotor of claim 8, further comprising:
a first metal end disk and a second metal end disk arranged at opposite sides of the stack of laminations, respectively,
wherein opposite ends the plurality of segmented rotor bars extend into corresponding cavities in the first and second metal end disks.

10. The rotor of claim 9, wherein the opposite ends of the plurality of segmented rotor bars are welded to the first and second metal end disks.

11. The rotor of claim 9, wherein the first metal end disk and the second metal end disk have higher mechanical strength than the plurality of segmented rotor bars.

12. The rotor of claim 9, wherein the first metal end disk and the second metal end disk have lower electrical conductivity than the plurality of segmented rotor bars.

13. The rotor of claim 8, further comprising end caps cast around the opposite ends the plurality of segmented rotor bars.

14. An induction motor comprising:
a stator including windings; and
a rotor arranged inside of the stator and including:
a stack of rotor laminations;
a plurality of slots arranged adjacent to a radially outer edge of the stack of rotor laminations; and
a cage including a plurality of segmented rotor bars arranged in the plurality of slots and segmented in at least one of a radial direction and a circumferential direction.

15. The induction motor of claim 14, wherein the plurality of segmented rotor bars are segmented in one of a circumferential direction and a radial direction.

16. The induction motor of claim 14, wherein:
the plurality of segmented rotor bars include different cross sectional areas, and
the plurality of segmented rotor bars in each of the slots have a decreasing cross sectional area in a direction towards an air gap.

17. The induction motor of claim 14, wherein the plurality of segmented rotor bars include an insulating coating.

18. The induction motor of claim 14, further comprising:
a first metal end disk and a second metal end disk arranged at opposite sides of the stack of laminations,
wherein the plurality of segmented rotor bars extend in an axial direction beyond the stack of laminations,
wherein opposite ends the plurality of segmented rotor bars extend into cavities in the first and second metal end disks, and
wherein the opposite ends the plurality of segmented rotor bars are welded to the first and second metal end disks.

19. The induction motor of claim 14, further comprising:
first and second end caps,
wherein the plurality of segmented rotor bars extend in an axial direction beyond the stack of laminations, and
wherein the first and second end caps are cast around the opposite ends the plurality of segmented rotor bars.

20. A vehicle comprising:
an induction motor comprising:
a stator including windings; and
a rotor including:
a stack of rotor laminations;
a plurality of slots arranged adjacent to a radially outer edge of the stack of rotor laminations; and
a cage including a plurality of segmented rotor bars arranged in the plurality of slots and segmented in at least one of a radial direction and a circumferential direction,
wherein the plurality of segmented rotor bars include different cross sectional areas, and
the plurality of segmented rotor bars in each of the slots have a decreasing cross sectional area in a direction towards an air gap;
a battery system;
a power inverter configured to supply power from the battery system to the windings of the induction motor; and
at least one driven wheel propelled by the induction motor.
